(19) United States
(12) Patent Application Publication
(10) Pub. No.: US 2015/0301606 A1
(43) Pub. Date: Oct. 22, 2015

(54) TECHNIQUES FOR IMPROVED WEARABLE COMPUTING DEVICE GESTURE BASED INTERACTIONS

(71) Applicant: Valentin Andrei, Bucharest (RO)

(72) Inventor: Valentin Andrei, Bucharest (RO)

(21) Appl. No.: 14/256,076

(22) Filed: Apr. 18, 2014

(51) Int. Cl. G06F 3/01; G06F 1/16

(52) U.S. Cl. CPC G06F 3/017; G06F 3/011; G06F 1/163

(57) ABSTRACT

Techniques for improved wearable computing device gesture based interactions are described. For example, an apparatus may comprise a band comprising one or more sensors arranged around a circumference of the band to monitor muscle activity and logic, at least a portion of which is in hardware, the logic to detect changes in muscle activity based on signals received from one or more of the one or more sensors and to interpret the detected changes in muscle activity as one or more gestures to control the apparatus. Other embodiments are described and claimed.

### TECHNICAL FIELD

Techniques for improved gesture based interactions for wearable computing devices are described.

### BACKGROUND

Modern computing devices continue to evolve in variety of ways. One particular area in which computing devices have evolved is in the area of wearable computing devices that are becoming increasingly popular as stand-alone computing devices and as peripherals used in conjunction with other computing devices. Additionally, the functionality and processing power of wearable computing devices continues to increase. Moreover, the inclusion of an abundance of features has resulted in an increased reliance upon wearable computing devices for mobile computing tasks. As the ergonomics and form factor design of wearable computing devices continue to evolve, improvements in user interactions with the devices in diverse, easy to use and non-visually-intrusive manners become important considerations. Consequently, there exists a substantial need for improved gesture based interactions for a wearable computing device. It is with respect to these and other considerations that the embodiments described herein are needed.

### BRIEF DESCRIPTION OF THE DRAWINGS

FIG. 1 illustrates an embodiment of a first system.

FIG. 2 illustrates an embodiment of a second system

FIG. 3A illustrates an embodiment of a third system.

FIG. 3B illustrates an embodiment of a fourth system.

FIG. 4 illustrates an embodiment of a first operating environment.

FIG. 5 illustrates embodiments of a second and third operating environment.

FIG. 6 illustrates an embodiment of a fifth system.

FIG. 7 illustrates an embodiment of a sixth system.

FIG. 8 illustrates an embodiment of a first logic flow.

FIG. 9 illustrates an embodiment of a seventh system.

FIG. 10 illustrates an embodiment of a second logic flow.

FIG. 11 illustrates an embodiment of a storage medium.

FIG. 12 illustrates an embodiment of a computing architecture.

### DETAILED DESCRIPTION

Various embodiments are generally directed to an apparatus, method and other techniques for a wearable computing device and gesture based interactions associated with a wearable computing device. Some embodiments are particularly directed to an apparatus comprising a band comprising one or more sensors arranged around a circumference of the band to monitor muscle activity and logic, at least a portion of which is in hardware, the logic to detect changes in muscle activity based on signals received from one or more of the one or more sensors and to interpret the detected changes in muscle activity as one or more gestures to control the apparatus. Other embodiments are described and claimed.

The functionality of mobile computing devices, in particular wearable computing devices such as smart watches, fitness accessories and like, continues to increase as processing power and user acceptance of these devices continues to rise. While the functionality and processing power continue to increase, form factors continue to decrease in size creating potential problems with user interaction and user interface design. For example, a typical smart watch may include a relatively small touchscreen display and one or more physical input buttons. While somewhat useful, these currently available input/output (I/O) mechanisms are relatively limited.

Some currently available wearable computing devices may include rudimentary gesture based interaction mechanisms that rely on accelerometers to detect movement of the wearable computing device in three-dimensional (3D) space and to interpret that movement as a gesture. These embodiments may be lacking because they call attention to a user, reducing the user's privacy and they tend to cause a user to lose sight of the device while performing the gesture, thereby reducing the effectiveness and decreasing the quality of the user experience. Still other embodiments may rely on voice commands as an alternative user interaction mechanism, but these approaches include even less privacy, they tend to be inaccurate in crowds and other loud environments and they do not generally function as intended for uses with accents. As a result, a need exists for improved gesture based interaction techniques that provide accuracy, privacy and an enjoyable user experience that includes being non-visually-intrusive.

Some embodiments described herein may comprise a wearable computing device that comprises a band or wristband (used interchangeably hereinafter) comprising one or more sensors arranged around a circumference of the wristband to monitor muscle activity and logic, at least a portion of which is in hardware, the logic to detect changes in muscle activity based on signals received from one or more of the one or more sensors and to interpret the detected changes in muscle activity as one or more gestures to control the apparatus. While shown in several embodiments herein as comprising a standalone computing device, in various embodiments, the wearable computing device may be connected as a peripheral to a mobile computing device such as a smartphone, tablet, and/or computer to provide additional functionality and user interface mechanisms. The wearable computing device may be operative to interpret the detected changes in muscle activity and/or muscle contraction patters as gestures that are used to control the wearable computing device based on an action associated with the detected gesture. Other embodiments are described and claimed.

With general reference to notations and nomenclature used herein, the detailed description that follows may be presented in terms of program procedures executed on a computer or network of computers. These procedural descriptions and representations are used by those skilled in the art to most effectively convey the substance of their work to others skilled in the art.

A procedure is here and is generally conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein that form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

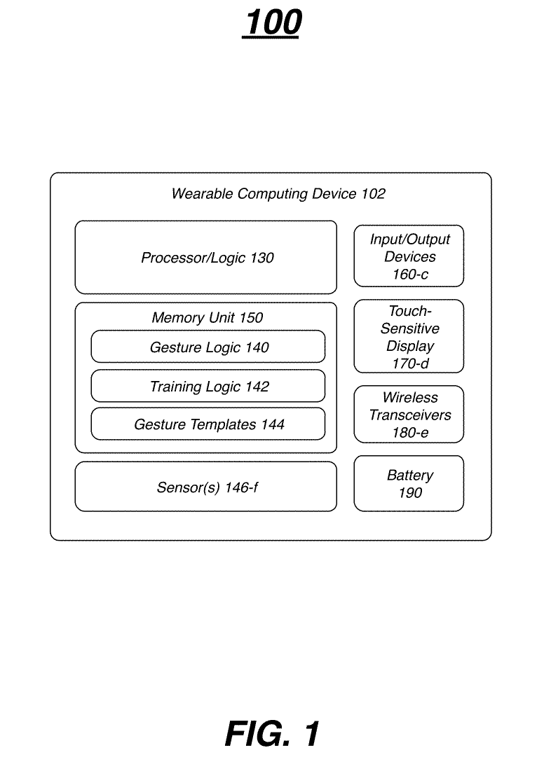

FIG. 1 illustrates a block diagram for a system 100 or an apparatus 100. In one embodiment, the system or apparatus 100 (referred to hereinafter as system 100) may comprise a computer-based system comprising electronic/computing device 102. In some embodiments, computing device 102 may comprise a wearable computing device such as but not limited to a wristband or smart watch. While referred to hereinafter as a wristband 102 or wearable computing device 102 for purposes of simplicity and illustration, it should be understood that wearable computing device 102 may comprise any suitable form factor and still fall within the described embodiments.

The wearable computing device 102 may comprise, for example, a processor 130, a memory unit 150, input/output devices 160-c, displays 170-d, one or more transceivers 180-e, one or more sensors 146-f and a battery 190. In some embodiments, the sensors 146-f may include one or more pressure sensors, heat sensors, infrared sensors, accelerometers, gyroscopes, a compass and/or a Global Positioning System (GPS) module. The wearable computing device 102 may further have installed or comprise gesture logic 140 and training logic 142. The memory unit 150 may store an unexecuted version of the gesture logic 140 and/or training logic 142 and one or more gesture templates 144. While the gesture logic 140, training logic 142 and gesture templates 144 are shown as separate components or modules in FIG. 1, it should be understood that one or more of the gesture logic 140, training logic 142 and gesture templates 144 could be part of any other application and/or part of an operating system (OS) and still fall within the described embodiments. Also, although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for e=5, then a complete set of wireless transceivers 180 may include wireless transceivers 180-1, 180-2, 180-3, 180-4 and 180-5. The embodiments are not limited in this context.

While not shown in FIG. 1, in various embodiments one or more components of wearable computing device 102 may comprise or be arranged as part of a different computing device, separate and distinct from wearable computing device 102, and still fall within the described embodiments. For example, the processor 130 may be part of a computing device (not shown) that is wirelessly coupled with the wearable computing device 102. Some examples of this additional computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In various embodiments, wearable computing device 102 may comprise logic and/or a processor 130. The processor 130 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processing 130.

In various embodiments, wearable computing device 102 may comprise a memory unit 150. The memory unit 150 may store, among other types of information, the gesture logic 140, training logic 142 and/or gesture templates 144 The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

In some embodiments, wearable computing device 102 may comprise one or more input/output devices 160-c. The one or more input/output devices 160-c may be arranged to provide functionality to the wearable computing device 102 including but not limited to capturing images, exchanging information, capturing or reproducing multimedia information, receiving user feedback, or any other suitable functionality. Non-limiting examples of input/output devices 160-c include a camera, QR reader/writer, bar code reader, buttons, switches, input/output ports such as a universal serial bus (USB) port, touch-sensitive sensors, pressure sensors, a touch-sensitive digital display and the like. The embodiments are not limited in this respect.

The wearable computing device 102 may comprise one or more displays 170-d in some embodiments. The displays 170-d may comprise any digital display device suitable for wearable computing device 102. For instance, the displays 170-d may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content to a user of the wearable computing device 102. The displays 170-d may further include some form of a backlight or brightness emitter as desired for a given implementation.

In various embodiments, the displays 170-d may comprise touch-sensitive or touchscreen displays. A touchscreen may comprise an electronic visual display that is operative to detect the presence and location of a touch within the display area or touch interface. In some embodiments, the display may be sensitive or responsive to touching of the display of the device with a finger or hand. In other embodiments, the display may be operative to sense other passive objects, such as a stylus or electronic pen. In various embodiments, displays 170-d may enable a user to interact directly with what is displayed, rather than indirectly with a pointer controlled by a mouse or touchpad. Other embodiments are described and claimed.

The wearable computing device 102 may comprise one or more wireless transceivers 180-e in some embodiments. Each of the wireless transceivers 180-e may be implemented as physical wireless adapters or virtual wireless adapters sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 180-e may comprise or implement various communication techniques to allow wearable computing device 102 to communicate with any number and type of other electronic devices. For instance, the wireless transceivers 180-e may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the wearable computing device 102 may implement different types of wireless transceivers 180-e. Each of the wireless transceivers 180-e may implement or utilize a same or different set of communication parameters to communicate information between various electronic devices. In one embodiment, for example, each of the wireless transceivers 180-e may implement or utilize a different set of communication parameters to communicate information between wearable computing device 102 and any number and type of other devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the wireless transceivers 180-e. The embodiments are not limited in this context.

In various embodiments, the wireless transceivers 180-e may implement different communication parameters offering varying bandwidths, communications speeds, or transmission range. For instance, a first wireless transceiver 180-1 may comprise a short-range interface implementing suitable communication parameters for shorter range communications of information, while a second wireless transceiver 180-2 may comprise a long-range interface implementing suitable communication parameters for longer range communications of information.

In various embodiments, the terms “short-range” and “long-range” may be relative terms referring to associated communications ranges (or distances) for associated wireless transceivers 180-e as compared to each other rather than an objective standard. In one embodiment, for example, the term “short-range” may refer to a communications range or distance for the first wireless transceiver 180-1 that is shorter than a communications range or distance for another wireless transceiver 180-e implemented for the wearable computing device 102, such as a second wireless transceiver 180-2. Similarly, the term “long-range” may refer to a communications range or distance for the second wireless transceiver 180-2 that is longer than a communications range or distance for another wireless transceiver 180-e implemented for the wearable computing device 102, such as the first wireless transceiver 180-1. The embodiments are not limited in this context.

In various embodiments, the terms “short-range” and “long-range” may be relative terms referring to associated communications ranges (or distances) for associated wireless transceivers 180-e as compared to an objective measure, such as provided by a communications standard, protocol or interface. In one embodiment, for example, the term “short-range” may refer to a communications range or distance for the first wireless transceiver 180-1 that is shorter than 300 meters or some other defined distance. Similarly, the term “long-range” may refer to a communications range or distance for the second wireless transceiver 180-2 that is longer than 300 meters or some other defined distance. The embodiments are not limited in this context.

In one embodiment, for example, the wireless transceiver 180-1 may comprise a radio designed to communicate information over a wireless personal area network (WPAN) or a wireless local area network (WLAN). The wireless transceiver 180-1 may be arranged to provide data communications functionality in accordance with different types of lower range wireless network systems or protocols. Examples of suitable WPAN systems offering lower range data communication services may include a Bluetooth system as defined by the Bluetooth Special Interest Group, an infra-red (IR) system, an Institute of Electrical and Electronics Engineers (IEEE) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented, and the embodiments are not limited in this context.

In one embodiment, for example, the wireless transceiver 180-2 may comprise a radio designed to communicate information over a wireless local area network (WLAN), a wireless metropolitan area network (WMAN), a wireless wide area network (WWAN), or a cellular radiotelephone system. The wireless transceiver 180-2 may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver 180-2 may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

In various embodiments, sensors 146-f may comprise any combination of sensors suitable for use in a wearable computing device 102. For example, in some embodiments the sensors 146-f may comprise one or more pressure sensors, force sensors, accelerometers, gyroscopes, a compass and/or a GPS module. Any suitable type of sensor could be used and still fall within the described embodiments as one skilled in the art would readily understand. In some embodiments, one or more of the sensors 146-f may comprise or be implemented using microelectromechanical systems (MEMS) technology. The sensors 146-f may comprise pressure and/or force sensors capable of monitoring contraction and extension of one or more muscles in one or more of a human arm, wrist or hand when the wearable computing device 102 is worn, for example, on a wrist of a user as a smart watch. The embodiments are not limited in this respect.

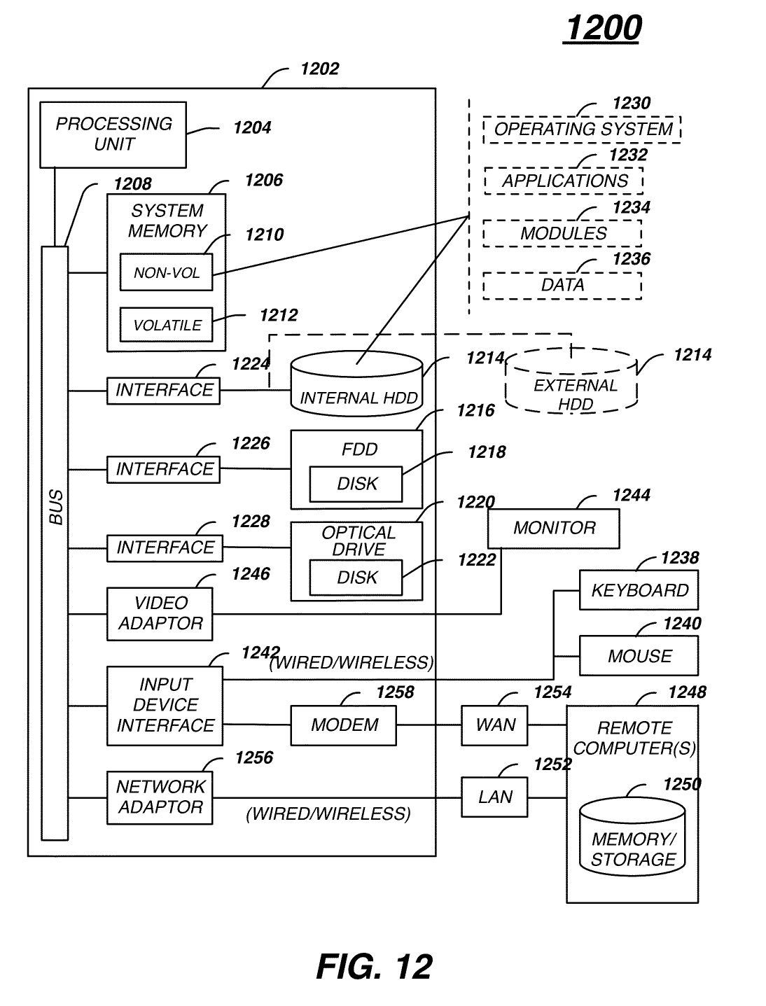

Although not shown, the wearable computing device 102 may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 12. The embodiments, however, are not limited to these examples.

In the illustrated embodiment shown in FIG. 1, the processor 130 may be communicatively coupled to the wireless transceivers 180-e and the memory unit 150. The memory unit 150 may store the gesture logic 140 and the training logic 142 arranged for execution by the processor 130 to enable gesture-based interactions. The gesture logic 140 may generally provide features to enable monitoring, detection and identification of gestures and to control the wearable computing device 102 based on the gestures. The training logic 142 may generally provide features to enable the evaluation and/or programming of new gestures and other information to/from wearable computing device 102. Other embodiments are described and claimed.

While various embodiments described herein include a wearable computing device 102 comprising a stand alone computing device, other embodiments may include separate devices including a wearable computing device 102 and a computing device such as a smartphone or tablet computing device. Similarly, while gesture logic 140, training logic 142 and gesture templates 144 are show in FIG. 1 as being part of or implemented by wearable computing device 102, in some embodiments these features may be included with or enabled by a different computing device. The embodiments are not limited in this respect.

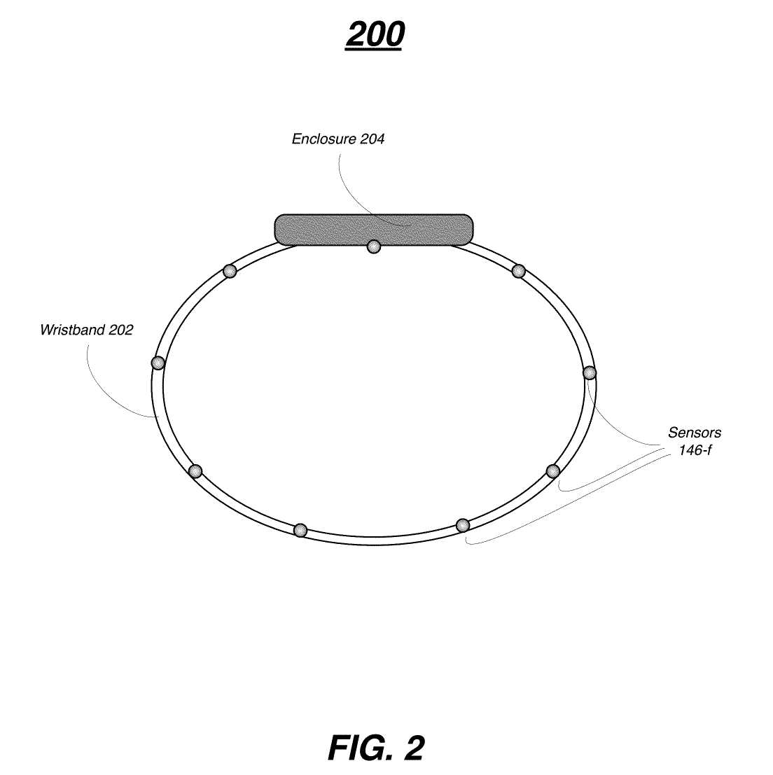

FIG. 2 illustrates a block diagram for a system 200. In some embodiments, the system 200 may represent one physical representation of one embodiment of a wearable computing device 102 of FIG. 1. As shown in FIG. 2, the system 200 may include a wristband 202, enclosure 204 and one or more sensors 146-f. Some examples of system 200 (referred to hereinafter as wearable computing device 102) may comprise a computing device arranged or operative to be worn on or by a user of the wearable computing device 102. Wearable computing device 102 may comprise a band, bracelet and/or one or more encircling strips or segments worn on the wrist of a user. In some embodiments, wearable computing device 102 may comprise any combination of suitable materials such as but no limited to rubber, plastic, elastic or metal. Wearable computing device 102 may comprise a watch-like or bracelet-like device that is arranged to enclose, support and/or protect a plurality of components in some embodiments. While not shown in FIG. 2, the wearable computing device 102 may include the same or similar components to the wearable computing device 102 of FIG. 1. The embodiments are not limited in this respect.

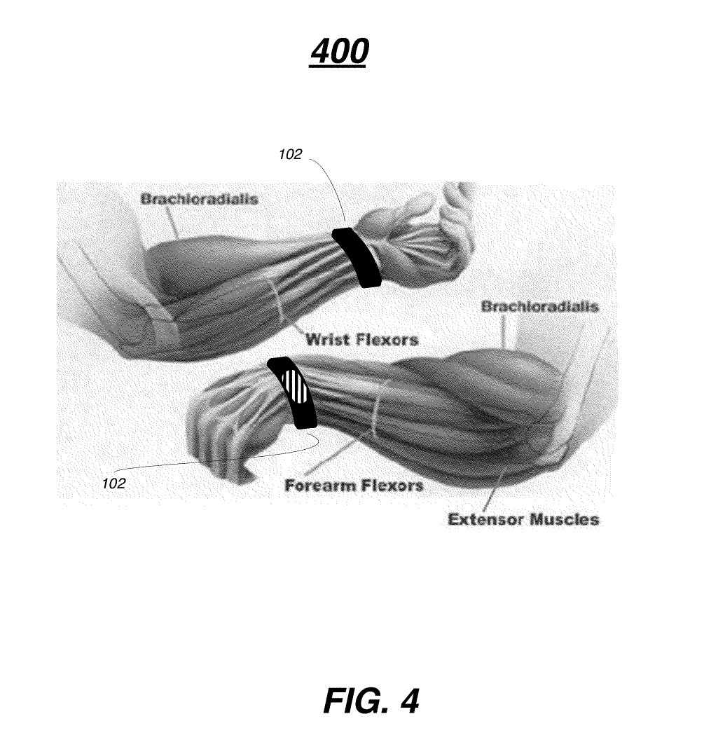

In various embodiments, the wearable computing device 102 may comprise one or more sensors 146-f arranged around a circumference of the wristband 202 of the wearable computing device 102 or substantially around the circumference of the wristband 202. The number, type and placement of sensors 146-f may vary and still fall within the described embodiments. For example, the sensors 146-f may comprise force and/or pressure sensors to monitor muscle activity and/or muscle contraction patters in some embodiments and an increased number of sensors 146-f may increase the accuracy of the detection but may also increase the cost of the device, the power consumption and the processing power. In some embodiments, the one or more sensors 146-f may comprise pressure sensors to monitor contraction and extension of one or more muscles in one or more of a human arm, wrist or hand as shown and described in more detail with reference to FIG. 4.

The one or more sensors 146-f may be communicatively coupled together using one or more flexible circuits in some embodiments. Moreover, as described in more detail elsewhere herein, the wristband 202 of wearable computing device 102 may be arranged to substantially encircle a portion of a human arm, wrist or hand. The wristband may comprise an elastic material or an adjustable closure to ensure contact between the one or more sensors and the human arm, wrist or hand. In other embodiments (not shown), the wristband 202 may comprise a plurality of segments arranged to individually enclose each of the plurality of sensors 146-f. The plurality of segments may define cavities or enclosure spaces to house the components of wearable computing device 102, including the sensors 146-f, and the segments may be coupled together to allow the wristband 202 to flex between the plurality of segments in various embodiments. In still other embodiments, the wristband 110 may comprise a smooth or textured surface instead of the plurality of segments.

The wristband 202 may be designed to flex, stretch or otherwise adapt to the shape of a user's wrist in various embodiments. In other embodiments, the wristband 202 may be adjustable (e.g. like a watch band) to accommodate different users. While shown and described as comprising a closed loop, it should be understood that the wristband 202 may comprise other configurations and still fall within the described embodiments. For example, the wristband 202 may be formed in a clasp-like or bangle-like manner where opposing ends of the wristband 202 may not be permanently connected. In other embodiments, the opposing ends of the wristband 202 may not be permanently connected, but may be removably connected or coupled by a magnet or other suitable attachment or closure device. In further embodiments, the wristband 202 may be designed to mechanically form into a shape designed to accommodate the wrist of a user, and my include sufficiently flexibility to allow a user to easily place the wristband 202 on their wrist, while then returning to its original shape. The embodiments are not limited in this respect.

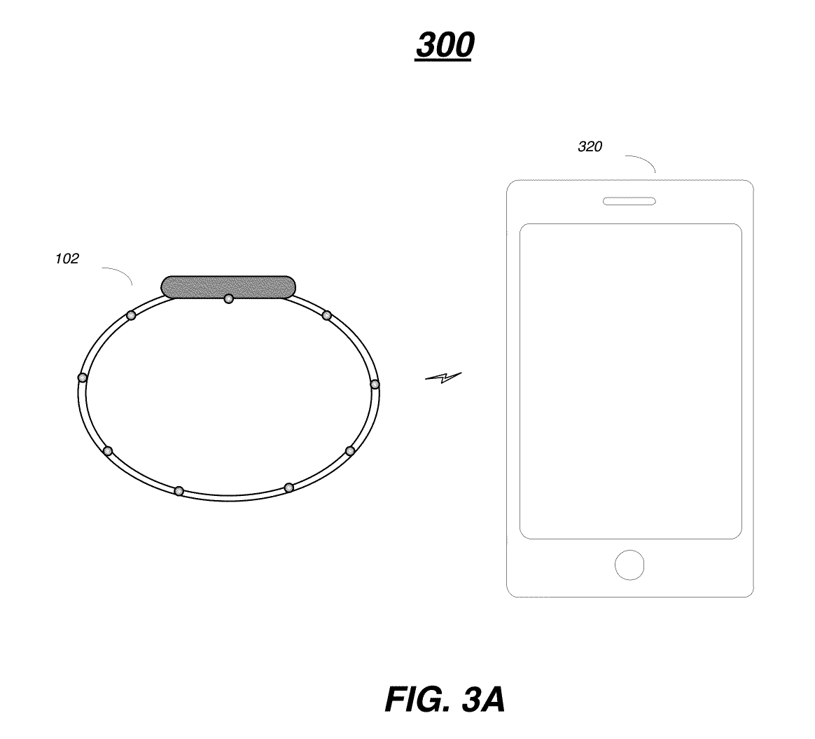

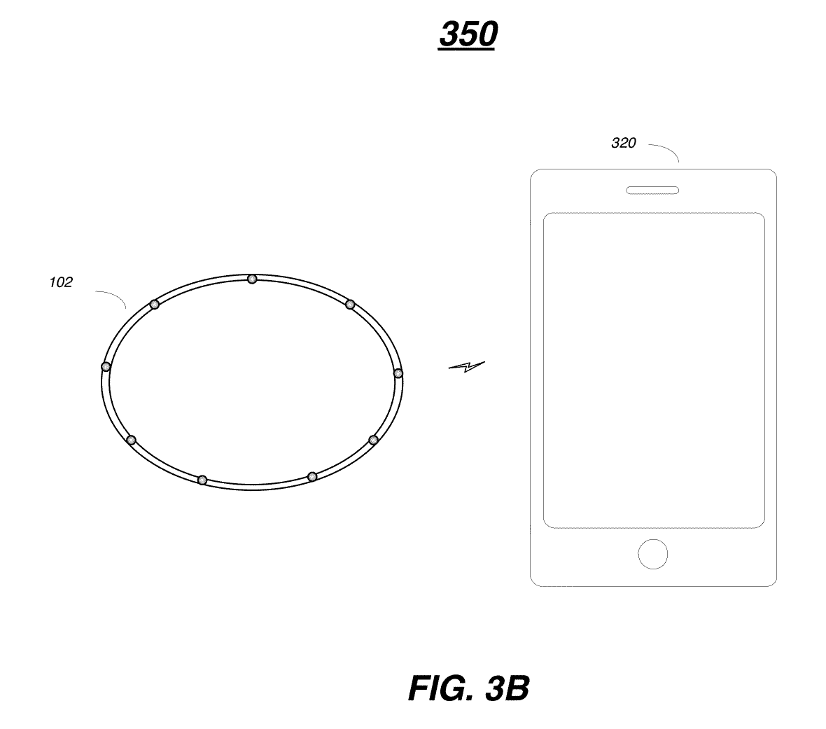

The wearable computing device 102 may include an enclosure 204 in some embodiments. The enclosure 204 may comprise any suitable enclosure, casing or housing arranged to support one or more components of wearable computing device 102. For example, enclosure 204 may comprise a watch-body-portion of the wearable computing device 102 arranged to support one or more of processor 130, memory 150, I/O devices 160-c, touch-sensitive display 170-d, wireless transceivers 180e, and/or battery 190. The enclosure 204 may also be mechanically, communicatively, removably and/or permanently coupled to band 202 in some embodiments. While shown in FIG. 2 as including enclosure 204, it should be understood that an enclosure 204 is not needed in all embodiments. For example, any of the above-referenced components of wearable computing device can be integrated into or as part of wristband 202 and still fall within the described embodiments. One such embodiment is shown in FIG. 3B.

FIG. 3A illustrates a block diagram for a system 300. In some embodiments, the system 300 may represent one physical representation of one embodiment of a wearable computing device 102 of FIG. 1 and a computing device 320. In various embodiments, as shown in FIG. 3A, the wearable computing device 102 may be wirelessly coupled or in wireless communication with a computing device 320 such as a smartphone, tablet computer or the like. In various embodiments, this wireless coupling may allow for the exchange of information, sharing of displays, controlling of the computing device 320 via the wearable computing device 102 and other similar operations.

FIG. 3B illustrates a block diagram for a system 350. In some embodiments, the system 300 350 represent one physical representation of one embodiment of a wearable computing device 102 of FIG. 1 and a computing device 320 and may be the same or similar to the system 300 of FIG. 3A. In various embodiments however, as shown in FIG. 3B, the wearable computing device 102 may not include an enclosure 204 as shown in FIG. 2. Instead, the wearable computing device 102 of FIG. 3B may rely on the computing power and display capabilities of computing device 320. In these embodiments, the wearable computing device 102 may act as more of a peripheral and/or control device for the computing device 320. The embodiments are not limited in this respect.

FIG. 4 illustrates an embodiment of a first operating environment 400 for the wearable computing device 102. More particularly, the operating environment 400 may illustrate the muscle and other activity that is captured by wearable computing device 102. As shown in FIG. 4, wearable computing device 102 may be worn, for example, on a wrist of a user (e.g. on the wrist or arm of a human). Movements of the digits, hand, wrist and arm involve muscle activity including but not limited to contraction and extension of any of the brachioradialis, wrist flexors, forearm flexors, extensor muscles and the like. If the wearable computing device 102 is properly worn and positioned on the user, these contractions and extensions may be monitored by sensors 146-f forming part of the wearable computing device 102. While all movement and muscle activity may be monitored by wearable computing device 102, it may be advantageous to monitor for, detect and act based on known muscle contraction patters comprising gestures in various embodiments.

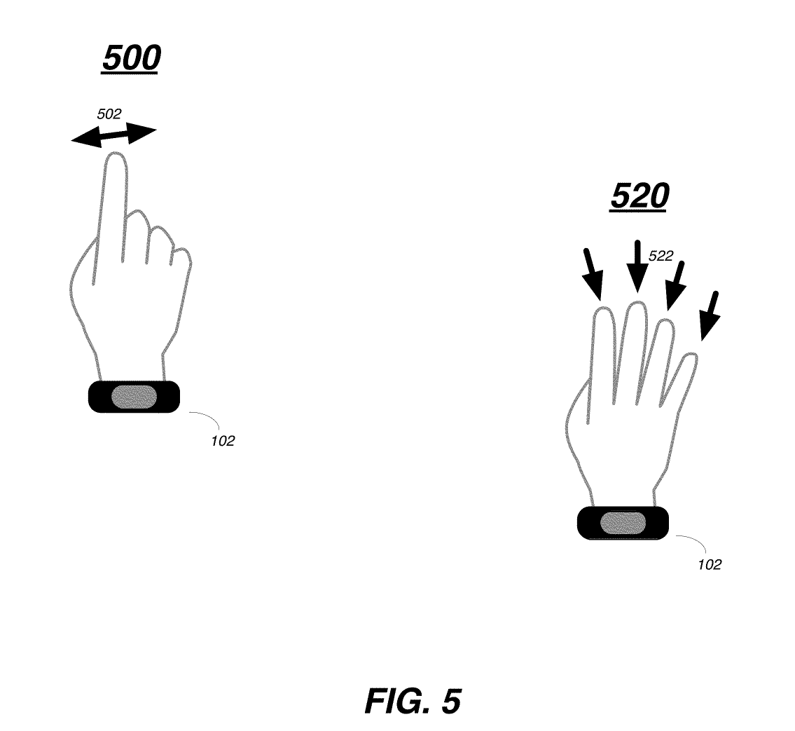

FIG. 5 illustrates an embodiment of a second operating environment 500 and a third operating environment 520 for the wearable computing device 102. More particularly, the operating environments 500 and 520 may illustrate example gestures used to control wearable computing device 102. As indicated above, the one or more gestures may comprise a recognizable muscle contraction pattern detected based on movement of one or more of a human arm, wrist, hand or one or more digits of the hand. In some embodiments, the movement of one or more of the human arm, wrist, hand or one or more digits of the hand may allow for continuous viewing of the wearable computing device 102 or a display of the wearable computing device 102 during the movement. The embodiments, however, are not limited in this respect.

As shown in operating environment 500, a user may extend a single digit or finger and may move the finger side to side as indicated by directional arrows 502. This movement may cause a recognizable muscle contraction pattern that is detectable by wearable computing device 102. Similarly, operating environment 520 may illustrates a gestures that includes a user extending and contracting four digits or fingers any number of times (e.g. opening and closing a first using four fingers) as indicated by directional arrows 522. This movement may also cause a recognizable muscle contraction pattern that is detectable by wearable computing device 102. While a limited number and type of movements and/or gestures are shown for purposes of illustration, one skilled in the art will appreciate that any suitable gesture could be used and still fall within the described embodiments. In various embodiments, however, the gestures may be limited to movements that are non-visually intrusive meaning a user is able to maintain viewing of the wearable computing device 102 and/or a display of the wearable computing device 102 while performing the gesture.

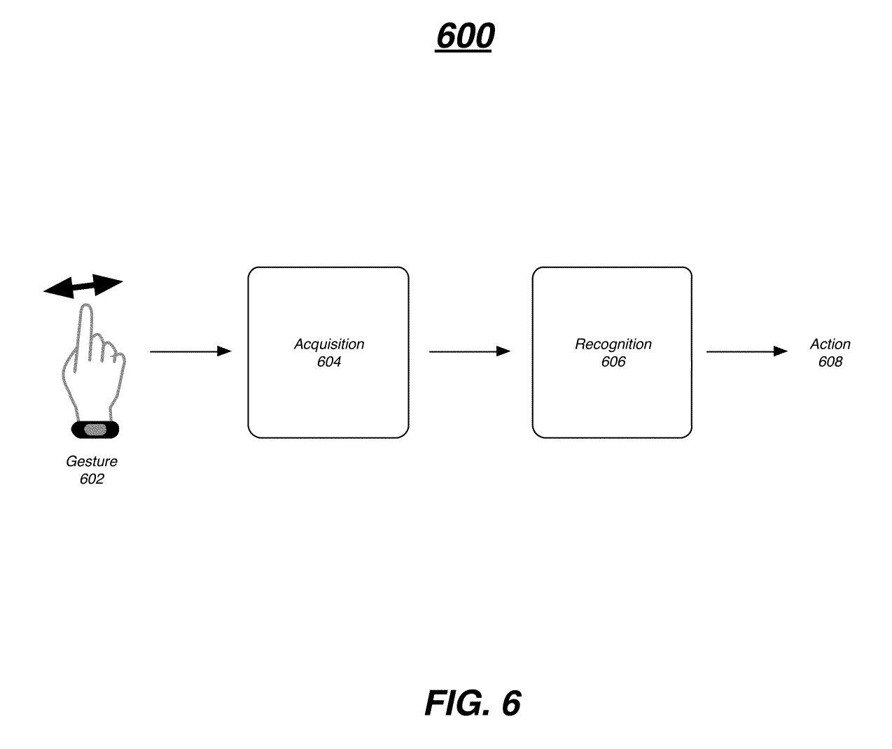

FIG. 6 illustrates a block diagram for a system and/or a logic flow 600. In some embodiments, the system 600 may represent the basic steps involved with performing a gesture, monitoring for and detecting a gesture, recognizing a gesture and performing a specified action associated with a gesture performed by a user wearing a wearable computing device such as wearable computing device 102 of FIG. 1. In various embodiments, the acquisition, recognition and action steps shown in FIG. 6 may be performed in whole or in part by gesture logic 140. The embodiments, however, are not limited in this respect.

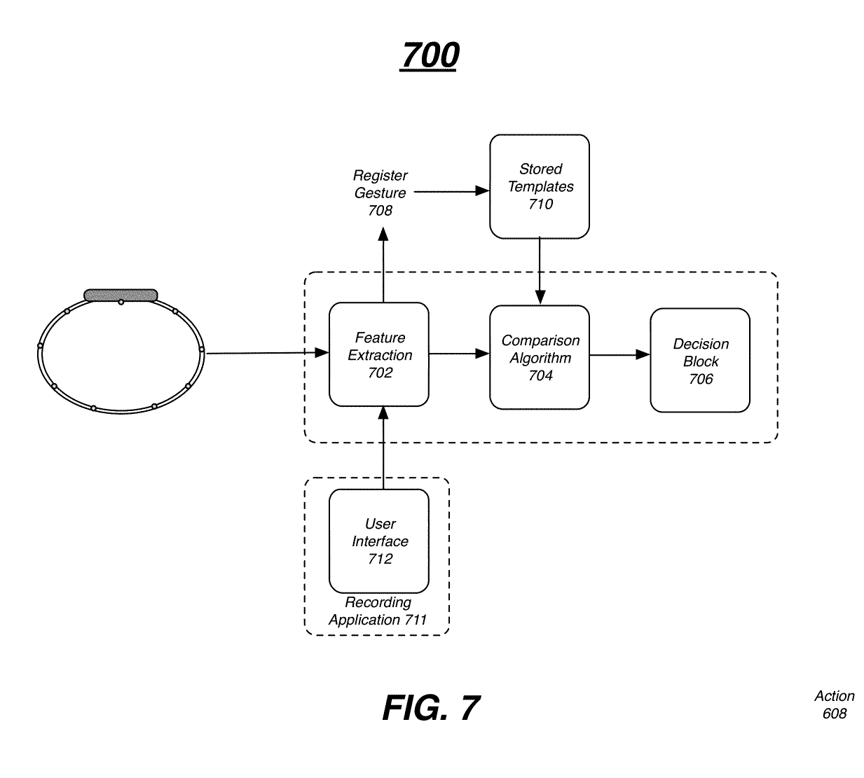

As shown in FIG. 6, the system 600 may include a gesture 602. As described above with respect to FIG. 5, the gesture may comprise changes in muscle activity detected by one or more sensors 146-f of wearable computing device 102. In some embodiments, the gesture 602 may be acquired by the wearable computing device 102 at 604. The acquisition 604 may comprise continuous monitoring for and detection of a gesture by gesture logic 140. For example, gesture logic 140, at least a portion of which may be in hardware, may monitor for and detect changes in muscle activity based on signals received from one or more of the one or more sensors 146-f. The recognition 606 may comprise comparing the detected gesture 602 to one or more gesture templates, such as gesture templates 144 and action 608 may comprise interpreting the detected changes in muscle activity as one or more gestures to control the wearable computing device 102. For example, the action 608 may comprise controlling the wearable computing device 102 based on an action associated with the detected gesture 602 if the detected gesture matches one of the one or more gesture templates 144. Additional details of the acquisition 604 and recognition 608 process are described with respect to FIG. 7.

FIG. 7 illustrates a block diagram for a system and/or a logic flow 700. In some embodiments, the system 700 may represent the basic steps involved with monitoring, detecting, acquiring and acting based on a gesture performed by a user wearing a wearable computing device such as wearable computing device 102 of FIG. 1. In various embodiments, the steps shown in FIG. 7 may be performed in whole or in part by gesture logic 140. The embodiments, however, are not limited in this respect.

As shown at 702, gesture logic 140 may extract one or more features from signals received from sensors 146-f of wearable computing device 102. For example, sensors 146-f may detect muscle contractions and extensions based on forced received at the sensors. This information may comprise the foundational features of a gesture. At 704 the gesture logic 140 may implement a comparison algorithm to compare the extracted features to one or more gesture templates 144. In other embodiments the extracted features may be registered as a gesture at 708 and stored as a template 710 prior to the comparison at 704.

Once the comparison of the extracted features and the gesture templates has been completed, a decision is made at block 706. For example, the decision block 406 may comprise taking an action if the extracted features match a gesture template. Actions may comprise any number or type of action with respect to wearable computing device 102. For example, a first gesture may correspond to an action of displaying a current time on the wearable computing device 102 while a second gesture may correspond to displaying a most recently received message on a display of the wearable computing device. One skilled in the art will readily understand that any number of gestures and corresponding actions could be used and still fall within the described embodiments.

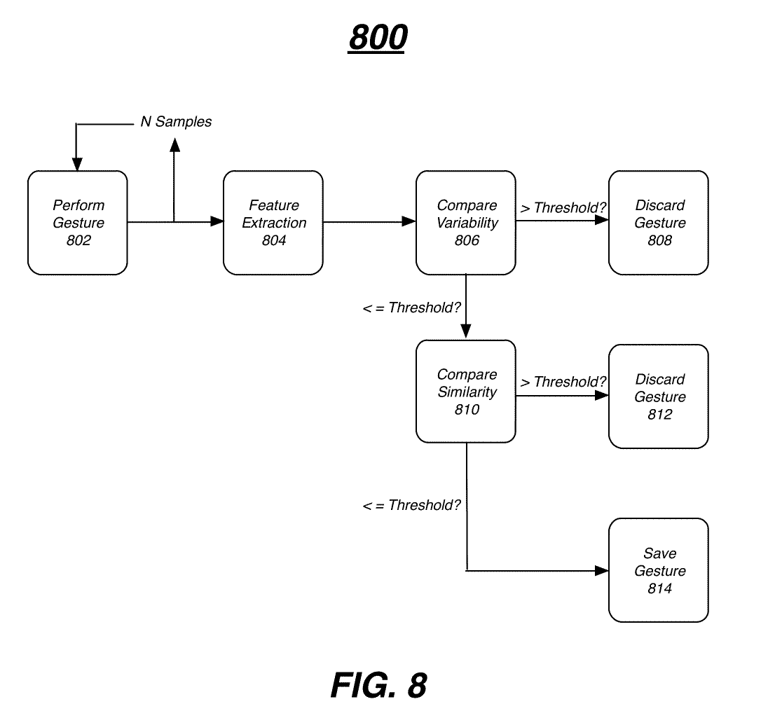

As also shown in FIG. 7, a recording application, including a user interface 712, may be included with wearable computing device 102. In some embodiments, the recording application may be utilized to record new gestures and assign the new gestures to associated actions. This training mode is described in more detail with reference to FIG. 8.

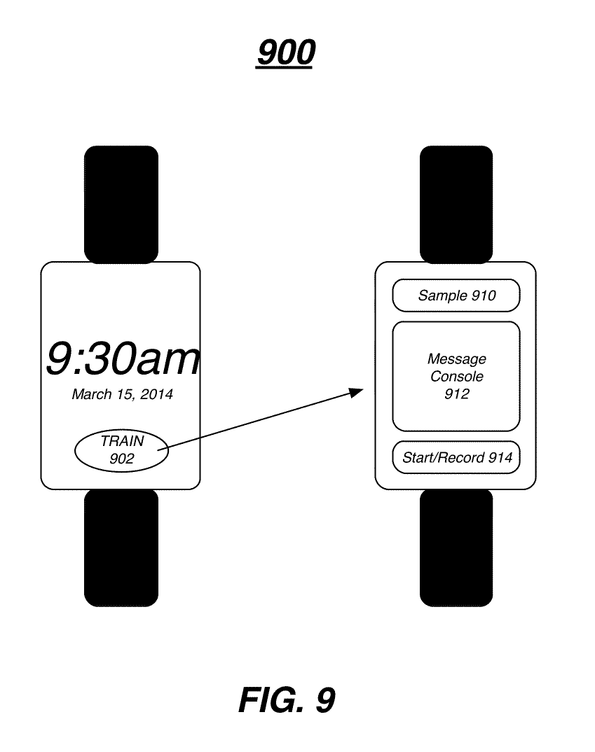

FIG. 8 illustrates a block diagram for a logic flow 800. In some embodiments, the logic flow 800 may represent the basic steps involved with training and/or recording new gestures for a wearable computing device such as wearable computing device 102 of FIG. 1. In various embodiments, the steps shown in FIG. 8 may be performed in whole or in part by gesture logic 140 and/or training logic 142. In some embodiments, the steps shown in FIG. 8 may comprise part of a training mode for wearing computing device 102 which may be entered automatically and/or manually as described in more detail with respect to FIG. 9. For example, the training mode may be initiated based on a signal received from one or more input devices of the wearable computing device 102, the one or more input devices comprising a mechanical input device, touch input device, or gesture input device.

At 802, while in the training mode, a gesture may be performed. For example, a user wearing wearable computing device 102 may executed an intended action that corresponds to a repeatable gesture. This gesture may be repeated N times and features may be extracted from the N samples of the gesture at 804. The extracted features from the detected multiple executions of the new gesture may be compared based on each of the multiple executions of the new gesture at 806. This comparison may include a determination of a variability of the new gesture. For example, if the new gesture is not repeatable (e.g. includes a high degree of variability), it may be determined that the gesture has variability exceeding a predetermined variability threshold. In these instances, the gesture is discarded at 808. If the comparison indicates that the new gestures is repeatable and the variability is less than or equal to the variability threshold, the gesture may be saved and another comparison may be performed at 810.

The training mode may include comparing a similarity of the new gesture to known/existing gestures (e.g. one or more of gesture templates 144). If the new gesture is too much like (e.g. too similar) an existing gesture templates, it may be determined that the new gesture has similarly greater than similarly threshold and the gesture may be discarded at 812. Otherwise, if the new gesture is substantially distinguishable from existing gesture templates, the gesture may be saved at 814. Other embodiments are described and claimed.

FIG. 9 illustrates one embodiments of an operating environment 900. For example, the operating environment may comprise one example embodiment of a wearable computing device such as wearable computing device 102 of FIG. 1. In various embodiments, the embodiments on the left of FIG. 9 may include a wearable computing device 102 in a normal operating mode including a display of the time, date and a GUI button 902. The GUI button 902 may comprise a soft or software enabled button used to initiate the above-described training mode. Upon initiation of the training mode based on a signal indicated that the button 902 has been activated or pressed, the user interface (UI) of the wearable computing device 102 may transition as shown on the right side of FIG. 9. For example, the UI may include a sample counter 910, a message console 912 and a start/record button 914. In some embodiments, the sample counter 910 may count down as a user executes the required N number of samples of a new gesture. The message console 912 may be used to display important information, such as alerting a user if a gesture was not detected, etc. In various embodiments, the start/record button 914 may comprise a soft or software button used to initiate the recording of each of the N samples of the new gesture. The embodiments are not limited in this respect.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

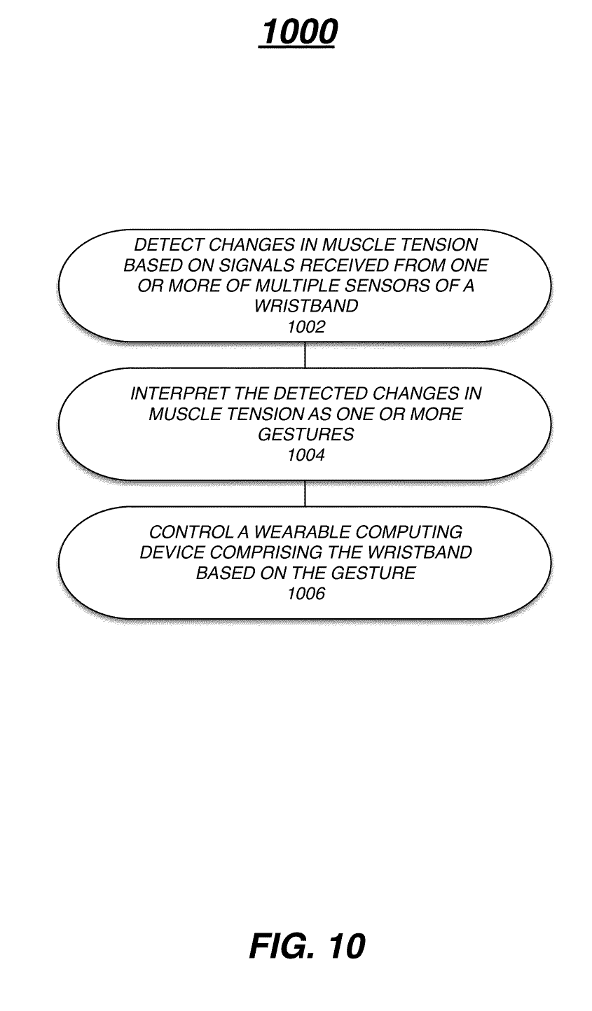

FIG. 10 illustrates one embodiment of a logic flow 1000. The logic flow 1000 may be representative of some or all of the operations executed by one or more embodiments described herein. For example, the logic flow 1000 may illustrate operations performed by a wearable computing device as described elsewhere herein.

In the illustrated embodiment shown in FIG. 10, the logic flow 1000 may include detecting changes in muscle activity based on signals received from one or more of one or more sensors of a wristband comprising one or more sensors arranged around a circumference of the wristband at 1002. For example, sensors 146-f of wearable computing device 102 may detect muscle contraction and extension as a user performs a gesture while wearing wearable computing device 102. At 1004 the logic flow may include interpreting the detected changes in muscle activity as one or more gestures at 1004 to control a wearable computing device comprising the wristband at 1006. For example, an action may be performed by wearable computing device 102 in response to the detected gesture. Other embodiments are described and claimed.

While not shown in FIG. 10, the in various embodiments the logic flow may include detecting a gesture, comparing the detected gesture to one or more gesture templates and controlling the wearable computing device based on an action associated with the detected gesture if the detected gesture matches one of the one or more gesture templates. In other embodiments, the logic flow may include receiving a signal from one or more input devices of the wearable computing device, the one or more input devices comprising a mechanical input device, touch input device, or gesture input device, initiating a training mode based on the received signal, and detecting multiple executions of a new gesture.

In some embodiments, the logic flow may include generating a graphical user interface (GUI) element for display on a display of the wearable computing device, the GUI element comprising instructions for executing a new gesture in the training mode. The logic flow may also include comparing features detected based on each of the multiple executions of the new gesture and determining a variability of the new gesture based on the comparison. In still other embodiments, the logic flow may include saving the new gesture if the variability is less than or equal to a variability threshold or disregarding the new gesture if the variability is greater than the variability threshold. The embodiments are not limited in this respect.

The logic flow may include comparing features of the new gesture to one or more gesture templates and determining a similarity of the new gesture and the one or more gesture templates in some embodiments. In various embodiments, the logic flow may include saving the new gesture if the similarity is less than or equal to a similarity threshold or disregarding the new gesture if the similarity is greater than the similarity threshold. Other embodiments are described and claimed.

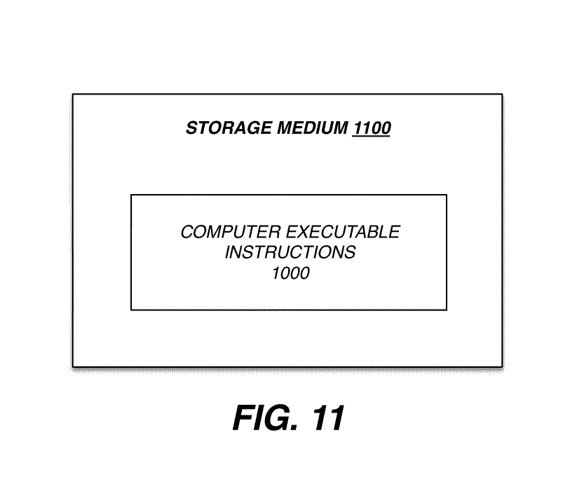

FIG. 11 illustrates an embodiment of a first storage medium. As shown in FIG. 11, the first storage medium includes a storage medium 1100. Storage medium 1100 may comprise an article of manufacture. In some examples, storage medium 1100 may include any non-transitory computer readable medium or machine readable medium, such as an optical, magnetic or semiconductor storage. Storage medium 1100 may store various types of computer executable instructions, such as instructions to implement logic flow 1000. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 12 illustrates an embodiment of an exemplary computing architecture 1200 suitable for implementing various embodiments as previously described. In one embodiment, the computing architecture 1200 may comprise or be implemented as part of wearable computing device 102.

As used in this application, the terms “system” and “component” are intended to refer to a computer-related entity, either hardware, a combination of hardware and software, software, or software in execution, examples of which are provided by the exemplary computing architecture 1200. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1200 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1200.

As shown in FIG. 12, the computing architecture 1200 comprises a processing unit 1204, a system memory 1206 and a system bus 1208. The processing unit 1204 can be any of various commercially available processors, such as those described with reference to the processor 130 shown in FIG. 1.

The system bus 1208 provides an interface for system components including, but not limited to, the system memory 1206 to the processing unit 1204. The system bus 1208 can be any of several types of bus structure that may further interconnect to a memory bus (with or without a memory controller), a peripheral bus, and a local bus using any of a variety of commercially available bus architectures. Interface adapters may connect to the system bus 1208 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1200 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1206 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computer 1202 may include various types of computer-readable storage media in the form of one or more lower speed memory units, including an internal (or external) hard disk drive (HDD) 1214, a magnetic floppy disk drive (FDD) 1216 to read from or write to a removable magnetic disk 1218, and an optical disk drive 1220 to read from or write to a removable optical disk 1222 (e.g., a CD-ROM or DVD). The HDD 1214, FDD 1216 and optical disk drive 1220 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236. In one embodiment, the one or more application programs 1232, other program modules 1234, and program data 1236 can include, for example, the various applications and/or components of the system 100.

A user can enter commands and information into the computer 1202 through one or more wire/wireless input devices, for example, a keyboard 1238 and a pointing device, such as a mouse 1240. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1204 through an input device interface 1242 that is coupled to the system bus 1208, but can be connected by other interfaces such as a parallel port, IEEE 1394 serial port, a game port, a USB port, an IR interface, and so forth.

A monitor 1244 or other type of display device is also connected to the system bus 1208 via an interface, such as a video adaptor 1246. The monitor 1244 may be internal or external to the computer 1202. In addition to the monitor 1244, a computer typically includes other peripheral output devices, such as speakers, printers, and so forth.

The computer 1202 may operate in a networked environment using logical connections via wire and/or wireless communications to one or more remote computers, such as a remote computer 1248. The remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the gesture recognition system 100 as previously described with reference to FIGS. 1-12 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty (1-30) provided below are intended to be exemplary and non-limiting.

In a first example, an apparatus may comprise a band comprising one or more sensors arranged around a circumference of the band to monitor muscle activity; and logic, at least a portion of which is in hardware, the logic to detect changes in muscle activity based on signals received from one or more of the one or more sensors and to interpret the detected changes in muscle activity as one or more gestures to control the apparatus.

In a second example of an apparatus, the apparatus may comprise a wearable computing device and the band to substantially encircle a portion of a human arm, wrist or hand.

In a third example of an apparatus, the one or more sensors may comprise pressure sensors to monitor contraction and extension of one or more muscles in one or more of a human arm, wrist or hand.

In a fourth example of an apparatus, the band may comprise an elastic material or an adjustable closure to ensure contact between the one or more sensors and a human arm, wrist or hand.

In a fifth example of an apparatus, the one or more gestures may comprise a recognizable muscle contraction pattern detected based on movement of one or more of a human arm, wrist, hand or one or more digits of the hand.

In a sixth example of an apparatus, the movement of one or more of the human arm, wrist, hand or one or more digits of the hand may allow for continuous viewing of a display of the apparatus during the movement.

In a seventh example of an apparatus, the logic may detect a gesture, compare the detected gesture to one or more gesture templates, and control the apparatus based on an action associated with the detected gesture if the detected gesture matches one of the one or more gesture templates.

In a eighth example of an apparatus, the logic may initiate a training mode based on a signal received from one or more input devices of the apparatus, the one or more input devices comprising a mechanical input device, touch input device, or gesture input device, and detect multiple executions of a new gesture.

In a ninth example of an apparatus, the logic may compare features detected based on each of the multiple executions of the new gesture, determine a variability of the new gesture based on the comparison, save the new gesture if the variability is less than or equal to a variability threshold, and disregard the new gesture if the variability is greater than the variability threshold.

In a tenth example of an apparatus, the logic may compare features of the new gesture to one or more gesture templates, determine a similarity of the new gesture and the one or more gesture templates, save the new gesture if the similarity is less than or equal to a similarity threshold, and disregard the new gesture if the similarity is greater than the similarity threshold.

In an eleventh example of an apparatus, the one or more sensors may be communicatively coupled together using one or more flexible circuits.

In a twelfth example, a computer-implemented method may comprise detecting changes in muscle activity based on signals received from one or more of one or more sensors of a band comprising one or more sensors arranged around a circumference of the band, and interpreting the detected changes in muscle activity as one or more gestures to control a wearable computing device comprising the band.

In a thirteenth example, a computer-implemented method may comprise detecting a gesture, comparing the detected gesture to one or more gesture templates, and controlling the wearable computing device based on an action associated with the detected gesture if the detected gesture matches one of the one or more gesture templates.

In a fourteenth example, a computer-implemented method may comprise receiving a signal from one or more input devices of the wearable computing device, the one or more input devices comprising a mechanical input device, touch input device, or gesture input device, initiating a training mode based on the received signal, and detecting multiple executions of a new gesture.

In a fifteenth example, a computer-implemented method may comprise generating a graphical user interface (GUI) element for display on a display of the wearable computing device, the GUI element comprising instructions for executing a new gesture in the training mode.

In a sixteenth example, a computer-implemented method may comprise comparing features detected based on each of the multiple executions of the new gesture and determining a variability of the new gesture based on the comparison.

In a seventeenth example, a computer-implemented method may comprise saving the new gesture if the variability is less than or equal to a variability threshold or disregarding the new gesture if the variability is greater than the variability threshold.

In an eighteenth example, a computer-implemented method may comprise comparing features of the new gesture to one or more gesture template and determining a similarity of the new gesture and the one or more gesture templates.

In a nineteenth example, a computer-implemented method may comprise saving the new gesture if the similarity is less than or equal to a similarity threshold or disregarding the new gesture if the similarity is greater than the similarity threshold.

In a twentieth example, an article may comprise a non-transitory storage medium containing a plurality of instructions that if executed enable a system to detect changes in muscle activity based on signals received from one or more of one or more sensors of a band comprising one or more sensors arranged around a circumference of the band and interpret the detected changes in muscle activity as one or more gestures to control a wearable computing device comprising the band.

In a twenty-first example, the article may comprise instructions that if executed enable the system to detect a gesture, compare the detected gesture to one or more gesture templates, and control the wearable computing device based on an action associated with the detected gesture if the detected gesture matches one of the one or more gesture templates.

In a twenty-second example, the article may comprise instructions that if executed enable the system to receive a signal from one or more input devices of the wearable computing device, the one or more input devices comprising a mechanical input device, touch input device, or gesture input device, initiate a training mode based on the received signal, and detect multiple executions of a new gesture.

In a twenty-third example, the article may comprise instructions that if executed enable the system to generate a graphical user interface (GUI) element for display on a display of the wearable computing device, the GUI element comprising instructions for executing a new gesture in the training mode.

In a twenty-fourth example, the article may comprise instructions that if executed enable the system to compare features detected based on each of the multiple executions of the new gesture and determine a variability of the new gesture based on the comparison.

In a twenty-fifth example, the article may comprise instructions that if executed enable the system to save the new gesture if the variability is less than or equal to a variability threshold or disregard the new gesture if the variability is greater than the variability threshold.

In a twenty-sixth example, the article may comprise instructions that if executed enable the system to compare features of the new gesture to one or more gesture templates and determine a similarity of the new gesture and the one or more gesture templates.

In a twenty-seventh example, the article may comprise instructions that if executed enable the system to save the new gesture if the similarity is less than or equal to a similarity threshold or disregard the new gesture if the similarity is greater than the similarity threshold.

In a twenty-eighth example, an apparatus may comprise means for performing the method of any of examples twelve to nineteen.

In a twenty-ninth example, at least one machine-readable medium comprising a plurality of instructions that in response to being executed on a computing device cause the computing device may carry out a method according to any of examples twelve to nineteen.

In a thirtieth example, a wearable computing device may be arranged to perform the method of any of examples twelve to nineteen.

Other embodiments are described and claimed.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a band comprising one or more sensors arranged around a circumference of the band to monitor muscle activity; and
logic, at least a portion of which is in hardware, the logic to detect changes in muscle activity based on signals received from one or more of the one or more sensors and to interpret the detected changes in muscle activity as one or more gestures to control the apparatus.

2. The apparatus of claim 1, the apparatus comprising a wearable computing device and the band to substantially encircle a portion of a human arm, wrist or hand.

3. The apparatus of claim 1, the one or more sensors comprising pressure sensors to monitor contraction and extension of one or more muscles in one or more of a human arm, wrist or hand.

4. The apparatus of claim 1, the band comprising an elastic material or an adjustable closure to ensure contact between the one or more sensors and a human arm, wrist or hand.

5. The apparatus of claim 1, the one or more gestures comprising a recognizable muscle contraction pattern detected based on movement of one or more of a human arm, wrist, hand or one or more digits of the hand.

6. The apparatus of claim 5, the movement of one or more of the human arm, wrist, hand or one or more digits of the hand allowing for continuous viewing of a display of the apparatus during the movement.

7. The apparatus of claim 1, the logic to:
detect a gesture;
compare the detected gesture to one or more gesture templates; and
control the apparatus based on an action associated with the detected gesture if the detected gesture matches one of the one or more gesture templates.

8. The apparatus of claim 1, the logic to:
initiate a training mode based on a signal received from one or more input devices of the apparatus, the one or more input devices comprising a mechanical input device, touch input device, or gesture input device; and
detect multiple executions of a new gesture.

9. The apparatus of claim 8, the logic to:
compare features detected based on each of the multiple executions of the new gesture;
determine a variability of the new gesture based on the comparison;
save the new gesture if the variability is less than or equal to a variability threshold; and
disregard the new gesture if the variability is greater than the variability threshold.

10. The apparatus of claim 8, the logic to:
compare features of the new gesture to one or more gesture templates;
determine a similarity of the new gesture and the one or more gesture templates;
save the new gesture if the similarity is less than or equal to a similarity threshold; and
disregard the new gesture if the similarity is greater than the similarity threshold.

11. The apparatus of claim 1, the one or more sensors communicatively coupled together using one or more flexible circuits.

12. A computer-implemented method, comprising:
detecting changes in muscle activity based on signals received from one or more of one or more sensors of a band comprising one or more sensors arranged around a circumference of the band; and
interpreting the detected changes in muscle activity as one or more gestures to control a wearable computing device comprising the band.

13. The computer-implemented method of claim 12, comprising:
detecting a gesture;
comparing the detected gesture to one or more gesture templates; and
controlling the wearable computing device based on an action associated with the detected gesture if the detected gesture matches one of the one or more gesture templates.

14. The computer-implemented method of claim 12, comprising:
receiving a signal from one or more input devices of the wearable computing device, the one or more input devices comprising a mechanical input device, touch input device, or gesture input device;
initiating a training mode based on the received signal; and
detecting multiple executions of a new gesture.

15. The computer-implemented method of claim 14, comprising:
generating a graphical user interface (GUI) element for display on a display of the wearable computing device, the GUI element comprising instructions for executing a new gesture in the training mode.

16. The computer-implemented method of claim 14, comprising:
comparing features detected based on each of the multiple executions of the new gesture; and
determining a variability of the new gesture based on the comparison.

17. The computer-implemented method of claim 16, comprising:
saving the new gesture if the variability is less than or equal to a variability threshold; or
disregarding the new gesture if the variability is greater than the variability threshold.

18. The computer-implemented method of claim 14, comprising:
comparing features of the new gesture to one or more gesture templates; and
determining a similarity of the new gesture and the one or more gesture templates.

19. The computer-implemented method of claim 18, comprising:
saving the new gesture if the similarity is less than or equal to a similarity threshold; or
disregarding the new gesture if the similarity is greater than the similarity threshold.

20. An article comprising a non-transitory storage medium containing a plurality of instructions that if executed enable a system to:
detect changes in muscle activity based on signals received from one or more of one or more sensors of a band comprising one or more sensors arranged around a circumference of the band; and
interpret the detected changes in muscle activity as one or more gestures to control a wearable computing device comprising the band.

21. The article of claim 20, comprising instructions that if executed enable the system to:
detect a gesture;
compare the detected gesture to one or more gesture templates; and
control the wearable computing device based on an action associated with the detected gesture if the detected gesture matches one of the one or more gesture templates.

22. The article of claim 20, comprising instructions that if executed enable the system to:
receive a signal from one or more input devices of the wearable computing device, the one or more input devices comprising a mechanical input device, touch input device, or gesture input device;
initiate a training mode based on the received signal; and
detect multiple executions of a new gesture.

23. The article of claim 22, comprising instructions that if executed enable the system to:
generate a graphical user interface (GUI) element for display on a display of the wearable computing device, the GUI element comprising instructions for executing a new gesture in the training mode.

24. The article of claim 22, comprising instructions that if executed enable the system to:
compare features detected based on each of the multiple executions of the new gesture;
determine one or more a variability of the new gesture based on the comparison;
compare features of the new gesture to one or more gesture templates; and
determine a similarity of the new gesture and the one or more gesture templates.

25. The article of claim 24, comprising instructions that if executed enable the system to:
save the new gesture if the variability is less than or equal to a variability threshold;
disregard the new gesture if the variability is greater than the variability threshold;
save the new gesture if the similarity is less than or equal to a similarity threshold; or
disregard the new gesture if the similarity is greater than the similarity threshold.
